(19) United States
(12) Patent Application Publication
(10) Pub. No.: US 2010/0216957 A1
(43) Pub. Date: Aug. 26, 2010

(54) CATALYST PREPARATION WITH PHOSPHOROUS COMPOUND

(75) Inventors: Anssi Haikarainen, Tuusula (FI); Peter Denifl, Helsinki (FI); Timo Leinonen, Tolkkinen (FI)

Correspondence Address: SEED INTELLECTUAL PROPERTY LAW GROUP PLLC, 701 FIFTH AVE, SUITE 5400, SEATTLE, WA, 98104, US

(73) Assignee: BOREALIS TECHNOLOGY OY, Porvoo (FI)

(21) Appl. No.: 12/521,104

(22) PCT Filed: Dec. 28, 2007
(86) PCT No.: PCT/EP2007/011459

§ 371 Date: Feb. 25, 2010

(30) Foreign Application Priority Data
Dec. 28, 2006 (EP) 06027029.5

(51) Int. Cl. C08F 4/16; C08F 4/60; C08F 4/606; C08F 4/609

(52) U.S. Cl. 526/145; 502/104; 502/119; 502/121

(57) ABSTRACT

The invention refers to a process for preparing a Group 2 metal/transition metal olefin polymerization catalyst component in particulate form having an improved polymerisation properties due to the addition of a phosphorous compound during catalyst component preparation and the use thereof in a process for polymerising olefins.

The invention relates to a particulate olefin polymerization catalyst component, particularly one comprising a Group 2 metal and to a process for preparing same. The invention also relates to the use of such a catalyst component for preparing a catalyst, and the use thereof in the polymerization of olefins.

### BACKGROUND OF THE INVENTION

Ziegler-Natta (ZN) type polyolefin catalysts are well known in the field of polymers, generally, they comprise (a) at least a catalyst component formed from a transition metal compound of Group 4 to 6 of the Periodic Table (IUPAC, Nomenclature of Inorganic Chemistry, 1989), a metal compound of Group 1 to 3 of the Periodic Table (IUPAC), and, optionally, a compound of group 13 of the Periodic Table (IUPAC) and/or an internal donor compound. ZN catalyst may also comprise (b) further catalyst component(s), such as a cocatalyst and/or an external donor.

Various methods for preparing ZN catalysts are known in the state of art. In one known method, a supported ZN catalyst system is prepared by impregnating the catalyst components on a particulate support material. In WO-A-01 55 230, the catalyst component(s) are supported on a porous, inorganic or organic particulate carrier material, such as silica.

In a further well known method the carrier material is based on one of the catalyst components, e.g. on a magnesium compound, such as MgCl₂. This type of carrier material can also be formed in various ways. EP-A-713 886 of Japan Olefins describes the formation of MgCl₂ adduct with an alcohol which is then emulsified and finally the resultant mixture is quenched to cause the solidification of the droplets.

Alternatively, EP-A-856 013 of BP discloses the formation of a solid Mg-based carrier, wherein the Mg-component containing phase is dispersed to a continuous phase and the dispersed Mg-phase is solidified by adding the two-phase mixture to a liquid hydrocarbon.

The formed solid carrier particles are normally treated with a transition metal compound and optionally with other compounds for forming the active catalyst.

Accordingly, in case of external carriers, some examples of which are disclosed above, the morphology of the carrier is one of the defining factors for the morphology of the final catalyst.

One disadvantage encountered with the supported catalyst systems is that a possible surface treatment (impregnation step) of the support with one or more catalytically active compounds may lead to non-uniform distribution of the active component(s) and in turn to an inhomogeneous polymer material.

EP 1273595 A1 discloses a method of preparing an olefin polymerization catalyst component comprising preparing a solution of a complex of a group 2 metal and an electron donor by reacting a compound of said metal with said electron donor or a precursor thereof, reacting said complex in solution with at least one compound of a transition metal to produce an emulsion, and solidifying and recovering solid catalyst component particles.

US H2060H discloses a catalyst system for use in olefinic polymerization, containing a solid titanium catalyst component prepared by contacting a titanium compound and a magnesium compound, an organoaluminium compound having at least one aluminium-carbon bond and an organosilicon compound comprising at least one cyclobutyl group.

US 2001/0018501 A1 discloses components of catalysts for the polymerization of olefins, comprising the reaction product of compounds of transition metals and support materials, wherein the support materials have a porosity of greater than 0.3 cm³/g.

WO-A-00 08073 and WO-A-00 08074 describe further methods for producing a solid ZN-catalyst, wherein a solution of a Mg-based compound and one or more further catalyst compounds are formed and the reaction product thereof is precipitated out of the solution by heating the system. Furthermore, EP-A-926 165 discloses another precipitating method, wherein a mixture of MgCl₂ and Mg-alkoxide is precipitated together with a Ti-compound to give a ZN catalyst.

EP-A-83 074 and EP-A-83 073 of Montedison disclose methods for producing a ZN catalyst or a precursor thereof, wherein an emulsion or dispersion of Mg and/or Ti compound is formed in an inert liquid medium or inert gas phase and said system is reacted with an Al-alkyl compound to precipitate a solid catalyst. According to examples said emulsion is then added to a larger volume of Al-compound in hexane and prepolymerised to cause the precipitation.

In general, a drawback of such precipitation methods is the difficulty to control the precipitation step and thus the morphology of the precipitating catalyst particles.

Furthermore, the precipitation of the catalyst component(s) may often proceed via a “tar-like” intermediate stage. Said undesired sticky precipitate agglomerates easily and sticks to the walls of the reactor. The morphology of the catalyst would then of course be lost.

WO 03/000757 describes a process for the preparation of an olefin polymerization catalyst component, enabling to prepare solid particles of a catalyst component comprising a group 2 metal together with a transition metal.

WO 2004/029112 discloses a further process for preparing an olefin polymerization catalyst component, wherein the process is further characterized in that a specific aluminum alkyl compound is brought into contact with the catalyst component, enabling a certain degree of activity increase at higher temperatures.

U.S. Pat. No. 5,413,979 describes a further method for the preparation of a solid procatalyst composition wherein support materials are impregnated with catalyst component precursors in order to obtain a catalyst component.

U.S. Pat. No. 4,294,948 finally discloses a process for preparing an olefin polymer or copolymer, employing a solid titanium catalyst component prepared by treating pulverized catalyst precursors with organo metallic compounds of a metal of any of groups I or III of the Periodic Table, characterized in that the catalyst preparation occurs using pulverized, solid and particulate precursor materials.

U.S. Pat. No. 6,767,857 B1 describes the formation of a pre-catalyst by reacting butylethylmagnesium with an alcohol, followed by contacting with a phosphorous compound, such as tri-butyl phosphate. The resulting mixture is precipitated using for example TiCl₄ in order to produce a MgCl₂ support for a polymerisation catalyst. Polymers produced with the support as described are disclosed as having a broad molecular weight distribution of from 6 to 10.

WO 03/000746 and WO 01/32718 disclose solid titanium complex catalysts for polymerization and copolymerization of olefins, prepared by a chemical reaction involving the use of a magnesium compound which is reacted with a phosphorous compound and a silicon compound. Solid particles may subsequently by obtained by precipitating the described reaction product with a transition metal compound, such as a titanium compound. The obtained solid particles are thereafter reacted with a titanium compound and an electron donor, resulting in solid catalyst component particles comprising a carrier core obtained by the precipitation, coated with the titanium compound and electron donor added to the precipitated particles.

The obtained catalyst components accordingly are supported catalyst components comprising a core material being the carrier, not showing polymerization activity, coated with catalytically active materials, comprising a transition metal component and an electron donor.

For typical ZN catalyst systems it is known that the control of the molecular weight distribution (MWD), in particular if narrow MWD polymers are desired is difficult to accomplish, so that for typical narrow MWD polyolefin materials single site catalysts (SSC) are used. It would however by a great advantage if also ZN catalysts would be available allowing a control of MWD, in particular without sacrificing polymerisation activity.

Accordingly, although much development work has been done in the field of Ziegler-Natta catalysts, there remains a need for alternative or improved methods of producing ZN catalysts with desirable properties.

It is of particular interest to obtain a catalyst in particulate form which results in good and desired polymer properties, and enables the control of MWD, and possibly also further polymer properties, such as content of xylene solubles (XS). I.e. the object of the invention is to provide a catalyst component, yielding a catalyst having a high activity enabling the production of polymers with narrow MWD as defined herein, and preferably allowing also a control of the XS.

### DESCRIPTION OF THE INVENTION

In view of the drawbacks of the prior art and the object identified above the present invention provides the subject matter as defined in claims 1 to 38.

It has been surprisingly found by the inventors of the present invention that catalyst particles having a good morphology, size and uniform particle size distribution can be obtained by the way of preparing Ziegler-Natta (ZN) type catalysts, for use in olefin polymerization, in particular for propylene polymerisation, identified in the prior art cited above, showing furthermore an increase of the control of molecular weight distribution. The produced catalyst components according to the invention have excellent morphology, good particle size distribution and yield polymerisation catalysts having a fully satisfactory activity and allowing the desired control of the MWD. According to the replica effect, the polymer particles produced by using the inventive catalyst have very good morphological properties, too. The inventive catalyst preparation is based on a liquid/liquid two-phase system where no separate external carrier materials such as silica or MgCl₂ are needed in order to get solid catalyst particles.

The present invention is therefore directed to a process for preparing an olefin polymerization catalyst component in the form of particles having a predetermined size range as defined in claim 1, said process comprising the steps of:
a) preparing a solution of a complex of a Group 2 metal and an electron donor by reacting a compound of said metal with said electron donor or a precursor thereof in an organic liquid reaction medium;
b) adding said solution of said complex to at least one compound of a transition metal to produce an emulsion the dispersed phase of which contains more than 50 mol % of the Group 2 metal in said complex;
c) agitating the emulsion in order to maintain the droplets of said dispersed phase within an average size range of 5 to 200 μm;
d) solidifying said droplets of the dispersed phase;
e) recovering the solidified particles of the olefin polymerization catalyst component;

wherein a phosphorous compound is added and brought into contact with the droplets of the dispersed phase of the agitated emulsion or the solidified particles before recovering the solidified particles in step e).

The catalyst component particles, as obtainable with the novel and inventive process as defined above, are characterized in that they do not comprise the conventional structure of an inactive central carrier material being coated with the catalytically active compounds and/or complexes, but show a uniform composition with the catalytically active compounds and/or complexes constituting the catalyst component particle.

Polymerization processes, where the catalysts of the invention are useful comprise at least one polymerization stage. Typically the polymerization process comprises additional polymerization stages or reactors. In one particular embodiment the process contains at least one bulk reactor zone and at least one gas phase reactor zone, each zones comprising at least one reactor and all reactors being arranged in cascade. In one particularly preferred embodiment the polymerization process for polymerizing olefins, in particular propylene optionally with comonomers, like ethylene or other α-olefins, comprises at least one bulk reactor and at least one gas phase reactor arranged in that order. In some preferred processes the process comprises one bulk reactor and at least two gas phase reactors. The process may further comprise pre- and post reactors. Prereactors comprise typically prepolymerisation reactors.

The inventors surprisingly found that by adding a small amount of a phosphorous compound as defined in claim 1, during the preparation of the catalyst component as described in claim 1, preferably to the magnesium complex, the liquid/liquid two-phase system during the catalyst component preparation prior to solidification, or to the washing liquid if such a washing step is conducted prior to the recovery of the catalyst component, a catalyst component is obtained yielding a polymerisation catalyst having a clearly improved ability to control MWD. In addition in some embodiments also the XS content can be controlled while not sacrificing polymerisation activity, without destroying the excellent catalyst morphology or, subsequently, polymer morphology. In addition the phosphorous content in the final catalyst is very low and in most cases below the detection limit, so that no further impurities are introduced into the polymer produced using the catalyst component of the present invention.

The improvements as established by the present invention can be demonstrated by comparing the polymerization activity of catalyst components prepared in accordance with the present invention, compared with catalyst components prepared in an identical manner, with the exception that no phosphorous compound is added before recovering the solidified particles. Such a comparison will demonstrate the improvements enabled by the present invention.

According to the results obtained by the inventors there seem to be three variables, which effect on the results, namely;
the adding step of P-compound
the amount of P-compound
the type of P-compound.

According to the findings of the inventors it appears to be preferable to add the phosphorous compound before the particle formation has been completed, or after completion of particle formation. Accordingly, the addition of the phosphorous compound may be effected from step a) until the completion of the particle formation, i.e. step d), or thereafter, for example in a subsequent washing step to be carried out after step d) but prior to step e). The completion of the particle formation is usually achieved when the remaining toluene-soluble components have been washed out from the catalyst particles during solidifying said particles. Thus, the phosphorous compound can be preferably added, in pure form or in the form of a solution, from the beginning of the formation of the solution according to step a) until adding it to the washing liquid, mostly toluene. It is in particular preferred to add the phosphorous compound to the washing liquid.

The addition amount of the phosphorous compound is typically selected so that a molar ratio of Group 2 metal and phosphorous is within the range of 0.05 to 1, preferably 0.1 to 0.5, more preferably 0.1 to 0.3, and most preferably 0.15 to 0.25, such as about 0.2.

The inventors have surprisingly found, however, that the amount of the final P content in the catalyst component is very small, and below the detection limit. However, in some embodiments small amounts of P can be detected in the final catalyst component, and the amount of P may be 0.8 wt.-% or less, preferably 0.6 wt.-% or less, more preferably 0.4 wt.-% or less.

The phosphorous compound to be used in accordance with the present invention typically is a compound comprising phosphorous in the oxidation state of +5 or +3, preferably +5. Suitable examples of phosphorous compounds of the oxidation state of phosphorous of +3 are phosphines, such as tri-alkyl or tri-aryl phosphines, such as tri-phenyl phosphine. Preferred however are, as indicated above, are phosphorous compounds comprising phosphorous in the oxidation state +5. Particular examples thereof are compounds of the formula O═P(R)₃ wherein the three residues R may be identical or different and may be selected among halogens, including Cl, Br, and I, preferably Cl, alkyls, alkenyls, aryls, phenyls with 1 to 20 C-atoms, preferably 1 to 16, more preferably 1 to 12 C-atoms, wherein the groups optionally may be substituted once or twice, preferably with any of the groups identified above. Still more preferably R are alkyls with 1 to 16 C-atoms, preferably 1 to 12, more preferably 1 to 8 C-atoms or Cl, and a particular example is O═PCl₃ which may be suitably used in particular when wishing to add the phosphorous compound already in step a) or b). Another group of particular examples thereof are compounds of the formula O═P(OR)₃ wherein the three residues R may be identical or different and may be selected among alkyls, alkenyls, aryls, phenyls with 1 to 20 C-atoms, preferably 1 to 16, more preferably 1 to 12 C-atoms, wherein the groups optionally may be substituted once or twice, preferably with any of the groups identified above and halogens, including Cl, Br, and I. Still more preferably R are alkyls with 1 to 16 C-atoms, preferably 1 to 12, more preferably 1 to 8 C-atoms, and Alkyls with 2 to 6 C-atoms are especially useful, such as tributyl phosphate.

The inventors found out that the phosphorous compounds to be used in the present invention as defined in claim 1 surprisingly enable a control of the MWD and in embodiments also of XS. Typically the catalyst component of the present invention enables the preparation of narrow MWD polymers, such as polymers with a MWD of below 4, although a ZN catalyst system is employed for polymerisation. The present invention enables the preparation of polymers with MWD values of as low as 3.9 or below, even below 3.7, such as from 3.3 to 3.5. It is even possible to achieve a MWD as low as 3.0 by using the catalyst component and catalyst according to the present invention. Polymers prepared under identical conditions, and with the same catalysts, i.e. solid catalysts without any external carrier, however with the exception of the phosphorous compound addition for the present invention, display MWD values typically being at least 10 to 15% higher, and typically 4 or more. Conventional supported ZN catalysts produce polypropylene having a MWD close to 5 or above. It has to be noted that the possibility to narrow the MWD from 4 to e.g. 3.7 or lower by using a ZN catalyst is remarkable and gives beneficial possibilities to control polymer properties. Further the catalyst component prepared in accordance with the present invention in embodiments also allows a control of XS, typically a decrease of XS, compared with polymerisations under identical conditions with the exception of the phosphorous compound addition for the present invention.

The new inventive method can be easily scaled up in order to avoid common up-scaling problems in the prior art which led to unsatisfied catalyst morphology and particle size distribution as well as reduced activity at higher temperature.

Preferably, the inventive process further comprises washing and drying said recovered solidified particles to obtain said catalyst component in a purified form.

The Group 2 metal used in step a) of the inventive process is preferably magnesium, and the liquid organic medium comprises preferably a C₆-C₁₀ aromatic hydrocarbon, preferably toluene.

As electron donor compound to be reacted with the Group 2 metal compound is preferably a mono- or diester of an aromatic carboxylic acid or diacid, the latter being able to form a chelate-like structured complex. Said aromatic carboxylic acid ester or diester can be formed in situ by reaction of an aromatic carboxylic acid chloride or diacid dichloride with a C₂-C₁₆ alkanol and/or diol, and is preferable dioctyl phthalate.

The reaction for the preparation of the Group 2 metal complex is generally carried out at a temperature of 20° to 80° C., and in case that the Group 2 metal is magnesium, the preparation of the magnesium complex is carried out at a temperature of 50° to 70° C.

The compound of a transition metal is preferably a compound of a Group 4 metal. The Group 4 metal is preferably titanium, and its compound to be reacted with the complex of a Group 2 is preferably a halide.

In a further embodiment of the invention, a compound of a transition metal used in the process can also contain organic ligands typically used in the field known as a single site catalyst.

In addition, during the catalyst component preparation a compound of Group 13, preferably a compound of aluminium having a general formula AlR₃₋ₙXₙ, wherein R stands for a straight chain or branched alkyl or alkoxy group having 1 to 20, preferably 1 to 10 and more preferably 1 to 6 carbon atoms, X independently represents a residue selected from the group of halogen, preferably chloride, and alkyl and n stands for 0, 1, 2 or 3, can be added as an optional compound to the catalyst component synthesis and brought it into contact with the droplets of the dispersed phase of the agitated emulsion before recovering the solidified particles in step e). I.e. the Al compound can be added at any step a) to d), or during the washing step after d), however, before the final recovery step e). Reference is made to WO 2004/029112 and to unpublished EP patent application 06011312.3.

In a still further embodiment of the invention, a compound of a transition metal can also be selected from Group 5 metals, Group 6 metals, Cu, Fe, Co, Ni and/or Pd compounds.

The complex of the Group 2 metal is preferably a magnesium complex. The invention will henceforth be described in relation to a preferred embodiment of the process, namely to a process for the preparation of a Ziegler-Natta type catalyst.

In a preferred embodiment, the present invention is directed to a process for producing catalyst components of the Ziegler-Natta type in the form of particles having a predetermined size range, said process comprising: preparing a solution of magnesium complex by reacting an alkoxy magnesium compound and an electron donor or precursor thereof in a C₆-C₁ₒ aromatic liquid reaction medium; reacting said magnesium complex with a compound of at least one four-valent Group 4 metal at a temperature greater than 10° C. and less than 60° C. to produce an emulsion of a denser, TiCl₄/toluene-insoluble, oil dispersed phase having, Group 4 metal/Mg mol ratio 0.1 to 10 in an oil disperse phase having Group 4 metal/Mg mol ratio 10 to 100; agitating the emulsion, optionally in the presence of an emulsion stabilizer and or a turbulence minimizing agent, in order to maintain the droplets of said dispersed phase within an average size range of 5 to 200 μm. The catalyst particles are obtained after solidifying said particles of the dispersed phase e.g. by heating.

The optional Al compound is added before the final recovery, preferably during the washing step.

The said disperse and dispersed phases are thus distinguishable from one another by the fact that the denser oil, if contacted with a solution of titanium tetrachloride in toluene, will not dissolve in it. A suitable solution for establishing this criterion would be one having a toluene mol ratio of 0.1 to 0.3. They are also distinguishable by the fact that the great preponderance of the Mg provided (as complex) for the reaction with the Group 4 metal compound is present in the dispersed phase, as revealed by comparison of the respective Group 4 metal/Mg mol ratios.

In effect, therefore, virtually the entirety of the reaction product of the Mg complex with the Group 4 metal—which is the precursor of the ultimate catalyst component—becomes the dispersed phase, and proceeds through the further processing steps to the final particulate form. The disperse phase, still containing a useful quantity of Group 4 metal, can be reprocessed for recovery of that metal.

The production of a two-phase, rather than single-phase (as in prior practice) reaction product is encouraged by carrying out the Mg complex/Group 4 metal compound reaction at low temperature, specifically above 10° C. but below 60° C., preferably between above 20° C. and below 50° C. Since the two phases will naturally tend to separate into a lower, denser phase and supernatant lighter phase, it is necessary to maintain the reaction product as an emulsion by agitation, preferably in the presence of an emulsion stabiliser.

The resulting particles from the dispersed phase of the emulsion are of a size, morphology (spherical shape) and uniformity which render the ultimate catalyst component extremely effective in olefin polymerization. This morphology is preserved during the heating to solidify the particles, and of course throughout the final washing and optional drying steps. It is, by contrast, difficult to the point of impossibility to achieve such morphology through precipitation, because of the fundamental uncontrollability of nucleation and growth, and the large number of variables which affect these events.

The electron donor is preferably an aromatic carboxylic acid ester, a typically ester being dioctyl phthalate. The donor may conveniently be formed in situ by reaction of an aromatic carboxylic acid chloride precursor with a C₂-C₁₆ alkanol and/or diol. The liquid reaction medium preferably comprises toluene.

Furthermore, emulsifying agents/emulsion stabilisers can be used additionally in a manner known in the art for facilitating the formation and/or stability of the emulsion. For the said purposes e.g. surfactants, e.g. a class based on acrylic or methacrylic polymers can be used. Preferably, said emulsion stabilizers are acrylic or methacrylic polymers, in particular those with medium sized ester side chains having more than 10, preferably more than 12 carbon atoms and preferably less than 30, and preferably 12 to 20 carbon atoms in the ester side chain. Particular preferred are unbranched C₁₂ to C₂₀ acrylates such as poly(hexadecyl)-methacrylate and poly(octadecyl)-methacrylate.

Furthermore, in some embodiments a turbulence minimizing agent (TMA) can be added to the reaction mixture in order to improve the emulsion formation and maintain the emulsion structure. By using said TMA, catalyst component particles can be obtained, said particles having very narrow size distribution.

Preferably, the TMA is added to the reaction mixture when the emulsion is formed, however in any case before solidification of the droplets of the dispersed phase starts in order to make sure that a quite uniform particle size distribution can be obtained.

Said TMA agent has to be inert and soluble in the reaction mixture under the reaction conditions, which means that polymers without polar groups are preferred.

Accordingly, said TMA or mixtures thereof are preferred as polymers having linear aliphatic carbon backbone chains, which might be branched with short side chains only in order to serve for uniform flow conditions when stirring. Said TMA is in particular preferably selected from α-olefin polymers of α-olefin monomers with 6 to 20 carbon atoms, like polyoctene, polynonene, polydecene, polyundecene or polydodecene or mixtures thereof, having the molecular weight and general backbone structure as defined before. Most preferable it is polydecene.

TMA can added to the emulsion in an amount of e.g. 1 to 1.000 ppm, preferably 5 to 100 ppm and more preferable 5 to 50 ppm, based on the total weight of the reaction mixture.

It has been found that the best results are obtained when the Group 4 metal/Mg mol ratio of the denser oil is 1 to 5, preferably 2 to 4, and that of the disperse phase oil is 55 to 65. Generally the ratio of the mol ratio Group 4 metal/Mg in the disperse phase oil to that in the denser oil is at least 10.

The optional Al compound is added in such an amount that the final catalyst component particles have Al content of 0.0 to 1 wt-%, preferably 0.1 to 0.8 wt-% or 0.02 to 0.5 wt-%. The preferred amounts depend to some extent on the Al compound, e.g. if an Al alkoxy compound is used, the preferred final Al amounts seem to be lower that if e.g. Al alkyl chloride compounds are used.

Solidification of the dispersed phase droplets by heating is suitably carried out at a temperature of 70-150° C., usually at 80-110° C., preferably at 90-110° C.

The finally obtained catalyst component is desirably in the form of particles having generally an average size range of 5 to 200 μm, preferably 10 to 100, more preferably 20 to 50 μm.

The present invention further comprehends an olefin polymerization catalyst comprising a catalyst component prepared as aforesaid, in association with an alkyl aluminium cocatalyst and optionally external donors, typically silane based donors, and the use of that polymerization catalyst for the polymerization Of C₂ to C₁₋₁₀-olefins.

This use enables the formation of polymers with narrow MWD despite the use of ZN catalysts. MWD values which may be achieved using the novel and inventive catalyst component of the present invention are values of 4 or less, preferably 3.8 or less, and more preferably 3.6 or less. In particular the present invention enables the preparation of polymers possessing such low MWD values when polymerising propylene, alone or together with comonomers such as ethylene or higher olefins with from 4 to 10 carbon atoms.

The reagents can be added to the aromatic reaction medium in any order. However it is preferred that in a first step the alkoxy magnesium compound is reacted with a carboxylic acid halide precursor of the electron donor to form an intermediate; and in a second step the obtained product is further reacted with the Group 4 metal. The magnesium compound preferably contains from 1 to 20 carbon atoms per alkoxy group, and the carboxylic acid should contain at least 8 carbon atoms.

Reaction of the magnesium compound, carboxylic acid halide and polyhydric alcohol proceeds satisfactorily at temperatures in the range 20 to 80° C., preferably 50 to 70° C. The product of that reaction, the “Mg complex”, is however reacted with the Group 4 metal compound at a lower temperature, contrary to previous practice, to bring about the formation of a two-phase, oil-in-oil, product.

Use of an aromatic medium for preparation of the Mg complex contributes to consistent product morphology and higher bulk density. Catalyst bulk density and morphology correlate with polymer product bulk density and morphology according to the so-called “replication effect”.

The technique adopted in the novel regimen of the invention is inherently more precise than that formerly employed, and thus further contributes to product consistency, as well as sharply reducing the volumes of solvent to be handled and thus improving process economics.

The reaction medium used as solvent can be aromatic or a mixture of aromatic and aliphatic hydrocarbons, the latter one containing preferably 5-9 carbon atoms, more preferably 5-7 carbon atoms, or mixtures thereof. Preferably, the liquid reaction medium used as solvent in the reaction is aromatic and is more preferably selected from hydrocarbons such as substituted and unsubstituted benzenes, preferably from alkylated benzenes, even more preferably from toluene and the xylenes, and is most preferably toluene. The molar ratio of said aromatic medium to magnesium is preferably less than 10, for instance from 4 to 10, preferably from 5 to 9.

The recovered particulate product is washed at least once, preferably at least twice, most preferably at least three times with a hydrocarbon, which preferably is selected from aromatic and aliphatic hydrocarbons, preferably with toluene, particularly with hot (e.g. 80 to 100° C.) toluene, which might include a smaller or higher amount of TiCl₄ in it. The amount of TiCl₄ can vary from a few vol-% to more than 50 vol-%, such as from 5 vol-% to 50 vol-%, preferably up to 30 vol-% and more preferably from 5 to 15 vol-%. It is also possible that at least one wash is done with 100 vol-% TiCl₄. One or several further washes after aromatic and/or TiCl₄ washes can be run with aliphatic hydrocarbons of 4 to 8 carbon atoms. Preferable these latter washings are performed with heptane and/or pentane. Washings can be done with hot (e.g. 90° C.) or cold (room temperature) hydrocarbons or combinations thereof. It is also possible that all washings will be done with the same solvent, e.g. toluene. According to the one preferred embodiment of the present invention the aluminium alkoxy compound to be used in the catalyst component preparation of the invention can be added to any of the washing mediums, however preferably not to the last or two last washings.

The washing can be optimized to give a catalyst component with novel and desirable properties. Finally, the washed catalyst component is recovered. It can further be dried, as by evaporation or flushing with nitrogen, or it can be slurried to an oily liquid without any drying step.

It is preferable that the intermediates as well as the final product of the process be distinct compounds with an essentially stoichiometric composition. Often, they are complexes. A complex is, according to Römpps Chemie-Lexicon, 7. Edition, Franckh'sche Verlagshandlung, W. Keller & Co., Stuttgart, 1973, page 1831, “a derived name of compounds of higher order, which originate from the combination of molecules, —unlike compounds of first order, in the creation of which atoms participate”.

The alkoxy magnesium compound group is preferably selected from the group consisting of magnesium dialkoxides, complexes of a magnesium dihalide and an alcohol, and complexes of a magnesium dihalide and a magnesium dialkoxide. It may be a reaction product of an alcohol and a magnesium compound selected from the group consisting of dialkyl magnesiums, alkyl magnesium alkoxides, alkyl magnesium halides and magnesium dihalides. It can further be selected from the group consisting of dialkyloxy magnesiums, diaryloxy magnesiums, alkyloxy magnesium halides, aryloxy magnesium halides, alkyl magnesium alkoxides, aryl magnesium alkoxides and alkyl magnesium aryloxides.

The magnesium dialkoxide may be the reaction product of a magnesium dihalide such as magnesium dichloride or a dialkyl magnesium of the formula R₂Mg, wherein each one of the two Rs is a similar or different C₁-C₂₀ alkyl, preferably a similar or different C₄-C₁₀ alkyl. Typical magnesium alkyls are ethylbutyl magnesium, dibutyl magnesium, dipropyl magnesium, propylbutyl magnesium, dipentyl magnesium, butylpentylmagnesium, butyloctyl magnesium and dioctyl magnesium. Most preferably, one R of the formula R₂Mg is a butyl group and the other R is an octyl group, i.e. the dialkyl magnesium compound is butyl octyl magnesium.

Typical alkyl-alkoxy magnesium compounds RMgOR, when used, are ethyl magnesium butoxide, butyl magnesium pentoxide, octyl magnesium butoxide and octyl magnesium octoxide.

Dialkyl magnesium, alkyl magnesium alkoxide or magnesium dihalide can react with a monohydric alcohol R′OH, or a mixture thereof with a polyhydric alcohol R′(OH)ₘ.

Typical C₁-C₂₀ monohydric alcohols are methanol, ethanol, n-propanol, iso-propanol, n-butanol, iso-butanol, sec.butanol, tert.butanol, n-amyl alcohol, iso-amyl alcohol, sec.amyl alcohol, tert.amyl alcohol, diethyl carbinol, akt. amyl alcohol, sec. isoamyl alcohol, tert.butyl carbinol. Typical C₆-C₁₀ monohydric alcohols are hexanol, 2-ethyl-butanol, 4-methyl-2-pentanol, 1-heptanol, 2-heptanol, 4-heptanol, 2,4-dimethyl-3-pentanol, 1-octanol, 2-octanol, 2-ethyl-1-hexanol, 1-nonanol, 5-nonanol, dilsobutyl carbinol, 1-decanol and 2,7-dimethyl-2-octanol. Typical >C₁₀ monohydric alcohols are n-1-undecanol, n-1-dodecanol, n-1-tridecanol, n-1-tetradecanol, n-1-pentadecanol, 1-hexadecanol, n-1-heptadecanol and n-1 octadecanol. The monohydric alcohols may be unsaturated, as long as they do not act as catalyst poisons.

Preferable monohydric alcohols are those of formula R′OH in which R′ is a C₂-C₁₆ alkyl group, most preferably a C₄-C₁₂ alkyl group, particularly 2-ethyl-1-hexanol.

The aromatic reaction medium may also contain a polyalcohol, which may be straight- or branched-chain. Typical C₂ to C₆ polyhydric alcohols may be straight-chain or branched and include ethylene glycol, propylene glycol, trimethylene glycol, 1,2-butylene glycol, 1,3-butylene glycol, 1,4-butylene glycol, 2,3-butylene glycol, 1,5-pentanediol, 1,6-hexanediol, 1,8-octanediol, pinacol, diethylene glycol, triethylene glycol, and triols such as glycerol, methylol propane and pentareythritol. The polyhydric alcohol can be selected on the basis of the activity and morphology it, gives the catalyst component.

Preferably, essentially all of the aromatic carboxylic acid ester is a reaction product of a carboxylic acid halide, preferably a dicarboxylic acid dihalide, more preferably an unsaturated α,β-dicarboxylic acid dihalide, most preferably phthalic acid dichloride, with the monohydric alcohol.

The compound of a fourvalent Group 4 metal compound containing a halogen is preferably a titanium tetrahalide. Equivalent to titanium tetrahalide is the combination of an alkoxy titanium halide and a halogenation agent therefore, which are able to form a titanium tetrahalide in situ. The most preferred halide is the chloride, for zirconium and hafnium as well as for titanium.

The reaction conditions used in the claimed process may be varied according to the used reactants and agents.

As is known, the addition of at least one halogenated hydrocarbon during the process can lead to further improved catalytic activity. Reactive halogenated hydrocarbons preferably have the formula R′″X′″ₙ wherein R′″ is an n-valent C₁-C₂₀ hydrocarbyl group, particularly a C₁-C₁₀ paraffin, X′″ is a halogen and n is an integer from 1 to 4.

Such chlorinated hydrocarbons include monochloromethane, dichloromethane, trichloromethane (chloroform), tetrachloromethane, monochloroethane, (1,1)-dichloroethane, (1,2)-dichloroethane, (1,1,1)-trichloroethane, (1,1,2)-trichloroethane, (1,1,1,2)-tetrachloroethane, (1,1,2,2) tetrachloroethane, pentachloroethane, hexachloroethane, (1)-chloropropane, (2)-chloropropane, (1,2)-dichloropropane, (1,3)-dichloropropane, (1,2,3)trichloropropane, (1)-chlorobutane, (2)-chlorobutane, isobutyl chloride, tert.butyl chloride, (1,4)-dichlorobutane, (1)-chloropentane, (1,5)-dichloropentane. The chlorinated hydrocarbons may also be unsaturated, provided that the unsaturation does not act as catalyst poison in the final catalyst component.

In the above formula, R′″ is preferably a mono- or bivalent C₁-C₁₀ alkyl group, independently, X′″ is preferably chlorine and, independently, n is preferably 1 or 2. Preferred compounds include butyl chloride (BuCl), dichloroalkanes such as (1,4)-dichlorobutane, and tertiary butyl chloride.

Though the catalyst component preparation according to the inventive method can be carried out batchwise, it is also preferable and possible to prepare the catalyst component semi-continuously or continuously. In such semi-continuous or continuous process, the solution of the complex of the group 2 metal and said electron donor, which is prepared by reacting the compound of said metal with said electron donor in an organic liquid reaction medium, is mixed with at least one compound of a transition metal, which might be solved in the same or different organic liquid reaction medium. The so obtained solution is then agitated, possibly in the presence of an emulsion stabilizer, and then the so-agitated emulsion is fed into a temperature gradient reactor, in which the emulsion is subjected a temperature gradient, thus leading to solidifying the droplets of a dispersed phase of the emulsion. The optional TMA is preferably contained in the solution of the complex or added to the solution before feeding the agitated solution to the temperature gradient reactor.

When feeding said agitated emulsion to the temperature gradient reactor, an inert solvent, in which the droplets are not soluble, can additionally be fed into that gradient reactor in order to improve the droplet formation and thus leading to a uniform grain size of the particles of the catalyst component, which are formed in the temperature gradient reactor when passing through said line. Such additional solvent might be the same as the organic liquid reaction medium, which is used for preparing the solution of the complex of the group 2 metal as explained above in more detail.

The solidified particles of the olefin polymerization catalyst component can subsequently be recovered by an in-stream filtering unit and then, optionally after some additional washing and drying steps in order to remove unreacted starting components, can be stored for further use. In one embodiment the catalyst can be fed after washing steps into the olefin polymerization reactor, so that a continuous preparation and feed to the reactor is guaranteed. It is also possible to mix the solidified and washed catalyst component with an oily fluidic liquid and store and use the catalyst component as a catalyst component-oil slurry. In this way the drying steps can be avoided, which might be sometimes detrimental to the catalyst components morphology. This oil-slurry method is described in general in EP1489110 of the applicant, incorporated herein by reference.

As it can be seen from the above description of the semi-continuous or continuous process, it is thus possible to use separated reaction vessels for the different process steps and to transfer the reaction products which are prepared in the respective reaction vessels and to feed them in-line into further reaction vessels for formation of the emulsion and, subsequently, of the solidified particles.

It is preferred to use a full-continuous process as the time saving in said process is remarkable. In such fully continuous process, the formation of the solidified particles could be carried out in the temperature gradient line in the kind of pipe reactor, which is sufficiently long and which is subjected said temperature gradient from the starting temperature in the lower range of 20 to 80° C. up to a “solidifying” temperature of 70 to 150° C. The temperature gradient is preferably obtained by means of heating the pipe reactor from the outside by applying normal heaters, microwaves, etc.

As mentioned before, a filtering unit might preferably be used for filtering the solidified particles from the solvent stream. For said filtering unit, various drums and sieving systems can be used, depending on the specific particle sizes.

The present invention also provides a process for polymerising olefins, as defined in claim 34. Preferably the olefins to be polymerised are olefins with 2 to 10 carbon atoms, in particular ethylene and/or propylene. Due to the use of the catalyst precursor in accordance with the present invention it is possible to control the MWD of the polymer produced to low values, of 3.9 or less, preferably 3.7 or less and more preferably 3.6 or less. MWD values of 3.3 to 3.5 and even as low as 3.0 are possible in accordance with the present invention by using the catalyst component and catalyst of the present invention. In embodiments of the present invention it is also possible to control the XS to low values, such as below 3 wt.-%, preferably below 2.5 wt.-%, and even below 2 wt.-%. XS values being even below 1.5 wt.-% are exemplified.

Finally the present invention also provides olefin polymers, as defined in claim 36. Preferably the olefins to be polymerised are olefins with 2 to 10 carbon atoms, in particular ethylene and/or propylene. Due to the use of the catalyst precursor in accordance with the present invention it is possible to control the MWD of the polymer produced, preferably a propylene homopolymer or copolymer, to low values, of 3.9 or less, preferably 3.7 or less and more preferably 3.6 or less. MWD values of 3.3 to 3.5 and even as low as 3.0 are possible in accordance with the present invention by using the catalyst component and catalyst of the present invention. In embodiments of the present invention it is also possible to control the XS to low values, such as below 3 wt.-%, preferably below 2.5 wt.-%, and even below 2 wt.-%. XS values being even below 1.5 wt.-% are exemplified.

Some preferred embodiments of the invention are described, by way of illustration, in the following examples.

In the examples the following measuring methods were used:

Melt Flow Rate, MFR₂: ISO 1133; 230° C., 2.16 kg load

Xylene solubles, XS: Xylene soluble fraction of product at 25° C.

### Determination of Xylene Soluble Fraction (XS)

2.0 g of polymer are dissolved in 250 ml p-xylene at 135° C. under agitation. After 30±2 minutes the solution is allowed to cool for 15 minutes at ambient temperature and then allowed to settle for 30 minutes at 25±0.5° C. The solution is filtered with filter paper into two 100 ml flasks.

The solution from the first 100 ml vessel is evaporated in nitrogen flow and the residue is dried under vacuum at 90° C. until constant weight is reached.

XS%=(100×m₁×v₀)/(m₀×v₁)

m₀=initial polymer amount (g)
m₁=weight of residue (g)
v₀=initial volume (ml)
v₁ volume of analysed sample (ml)

Mw means weight average molecular weight and Mn is the number average molecular weight determined in a known manner using size exclusion chromatography (SEC).

MWD means Mw/Mn, and is determined by said SEC method.

Ti and Mg amounts in catalyst components were measured by flame atomic absorption method.

### EXAMPLES

### Examples 1-3

### Preparation of the Mg Complex

A magnesium complex solution was prepared by adding, with stirring, 55.8 kg of a 20% solution in toluene of BOMAG A to 19.4 kg 2-ethylhexanol in a 150 l steel reactor. During the addition the reactor contents were maintained below 20° C. The temperature of the reaction mixture was then raised to 60° C. and held at that level for 30 minutes with stirring, at which time reaction was complete. 5.5 kg 1,2-phthaloyl dichloride was then added and stirring of the reaction mixture at 60° C. was continued for another 30 minutes. After cooling to room temperature a yellow solution was obtained.

28.4 g (25 mmol) of the obtained Mg complex was mixed with 0.69 ml (7.5 mmol) (example 1), 0.23 ml (2.5 mmol) (example 2) or 0.46 ml (5.0 mmol) (example 3) of POCl₃ and the obtained mixture 1, 2 or 3 was used in preparation of catalyst component.

### Preparation of the Catalyst Component

19.5 ml titanium tetrachloride were placed in a 300 ml glass reactor equipped with a mechanical stirrer. Mixing speed was adjusted to 170 rpm. In examples 1, 2 and 3, mixtures 1, 2 or 3 were added with stirring. 1.0 ml of a solution in toluene of 3.0 mg polydecene and 2.0 ml Viscoplex 1-254 were added to the stirred reaction mixture and the stirring was continued for 5 minutes. 10.0 ml n-heptane was added to the reaction mixture and stirring was continued additional 30 minutes. During the addition of the Mg-complex the reactor contents were maintained below 30° C.

The temperature of the reaction mixture was then slowly raised to 90° C. over a period of 20 minutes and held at that level for 30 minutes with stirring. After settling and syphoning the solids underwent washing with 100 ml toluene, where 0.11 ml of diethyl aluminium chloride (DEAC) was added, at 90° C. for 30 minutes, 60 ml heptane for 20 minutes at 90° C. and 60 ml pentane for 10 minutes at 25° C. Finally, the solids were dried at 60° C. by nitrogen purge, to yield a yellow, air-sensitive powder.

Catalyst component properties are disclosed in Table 1.

### Example 4

### Bulk Polymerisation of Propylene

The propylene bulk polymerisation was carried out in a stirred 5 l tank reactor. About 0.9 ml triethyl aluminium (TEA) as a co-catalyst, ca 0.12 ml cyclohexyl methyl dimethoxy silane (CMMS) as an external donor and 30 ml n-pentane were mixed and allowed to react for 5 minutes. Half of the mixture was then added to the polymerisation reactor and the other half was mixed with about 20 mg of a catalyst component of example 1. After additional 5 minutes the catalyst/TEA/donor/n-pentane mixture was added to the reactor. The Al/Ti mole ratio was 250 mol/mol and the Al/CMMS mole ratio was 10 mol/mol. 70 mmol hydrogen and 1400 g propylene were introduced into the reactor and the temperature was raised within ca 15 minutes to the polymerisation temperature of 80° C. The polymerisation time after reaching polymerisation temperature was 60 minutes, after which the polymer formed was taken out from the reactor. Polymerisation results are disclosed in Table 2.

### Example 5

Polymerisation was carried out as in example 4, but using the catalyst component prepared according to example 2.

### Example 6

Polymerisation was carried out as in example 4, but using the catalyst component prepared according to example 3.

### Example 7

Polymerisation was carried out as in example 6, but polymerisation temperature was 90° C. and as external donor was used bicyclopentyl dimethoxy silane.

### Example 8

### Preparation of Mg Complex

Mg complex was prepared as in example 1, but no phosphorous compound was added to the complex.

### Preparation of the Catalyst Component

19.5 ml titanium tetrachloride were placed in a 300 ml glass reactor equipped with a mechanical stirrer. Mixing speed was adjusted to 170 rpm. 28.4 g (25 mmol) of the Mg-complex was added with stirring. 1.0 ml of a solution in toluene of 3.0 mg polydecene and 2.0 ml Viscoplex 1-254 were added to the stirred reaction mixture and stirring was continued 5 minutes. After addition of 10.0 ml n-heptane, 1.36 ml (5 mmol) of tributyl phosphate ((BuO)₃PO) was added and stirring was continued for 30 minutes. During the addition of the Mg-complex the reactor contents were maintained below 30° C. The temperature of the reaction mixture was then slowly raised to 90° C. over a period of 20 minutes and held at that level for 30 minutes with stirring. After settling and syphoning the solids underwent washing with 100 ml toluene, where 0.11 ml of DEAC was added, at 90° C. for 30 minutes, 60 ml heptane for 20 minutes at 90° C. and 60 ml pentane for 10 minutes at 25° C. Finally, the solids were dried at 60° C. by nitrogen purge, to yield a yellow, air-sensitive powder.

Catalyst component properties are disclosed in Table 1.

### Example 9

### Bulk Polymerisation of Propylene

Polymerisation was carried out as in example 4, but using the catalyst component prepared according to example 8. Polymerisation results are disclosed in Table 2.

### Example 10

### Mg Complex Preparation

Mg complex was prepared as in example 8.

### Catalyst Component Preparation

Catalyst component was prepared as in example 8, but tributyl phosphate compound was added first to the toluene wash together with DEAC.

Catalyst component properties are disclosed in Table 1.

### Example 11

### Bulk Polymerisation of Propylene

Polymerisation was carried out as in example 4, but using the catalyst component prepared according to example 10. Polymerisation results are disclosed in Table 2.

### Comparative Example (CE) (No P Compound Added)

Mg complex was prepared as in example 8 (no phosphorous compound was added to the complex).

### Preparation of the Catalyst Component

Catalyst component was prepared as in example 8, but no phosphorous compound was added to the mixture.

Catalyst properties are disclosed in Table 1.

Polymerisation was carried out as in example 4, however, using catalyst component of the comparative example. Polymerisation results are given in Table 2.

TABLE 1
Catalyst component properties

| | | P/Mg | Ti | DOP | Mg |
|---|---|---|---|---|---|
| Example | P source | (mol/mol) | wt-% | wt-% | wt-% |
| 1 | POCl₃ | 0.3 | 4.96 | 23.5 | 12.3 |
| 2 | POCl₃ | 0.1 | 4.60 | 22.3 | 13.2 |
| 3 | POCl₃ | 0.2 | 4.47 | 22.4 | 13.3 |
| 8 | TBP | 0.2 | 2.57 | 22.0 | 14.9 |
| 10 | TBP | 0.2 | 4.41 | 22.4 | 13.3 |
| CE | no | 0 | 6.9 | 22.7 | 9.9 |

TBP = tributyl phosphate
the ratio P/Mg designates the molar ratio as used during preparation of catalyst component

TABLE 2
Polymerisation and polymer results

| | Ca. Comp | | | | |
|---|---|---|---|---|---|
| | of | Act. | | MFR₂ | |
| example | example | kgPP/gcat h | XS | g/10 min | MWD |
| 4 | 1 | 19.2 | 1.8 | 7.7 | 3.4 |
| 5 | 2 | 29.0 | 2.3 | 7.3 | 3.5 |
| 6 | 3 | 28.7 | 1.9 | 8.3 | 3.4 |
| 7 | 3 | 22.0 | 1.1 | 5.0 | 3.4 |
| 9 | 8 | 21.8 | 1.4 | 4.8 | 3.5 |
| 11 | 10 | 33.1 | 1.6 | 7.5 | 3.4 |
| CE | CE | 14.1 | 3.3 | 16.3 | 4.1 |

### Example 12

### Mg Complex Preparation

Mg complex was prepared as in example 8.

### Catalyst Component Preparation

Catalyst component was prepared as in example 10, however, no DEAC was added into the toluene wash solution, but only TBP was added (P/Mg mol/mol=0.2, the ratio P/Mg designates the molar ratio as used during preparation of catalyst component).

Catalyst component properties were as follows (wt-%):

Ti 2.97

Mg 12.7

DOP 27.3

P 0.36

### Example 13

### Bulk Polymerisation of Propylene

Polymerisation was carried out as in example 4, but using the catalyst component prepared according to example 12 and polymerisation temperature was 70° C.

### Polymerisation Results:

Activity: 27.3

MFR₂: 3.5

XS: 1.3

MWD: 3.9

### Example 14

Mg complex was prepared as in example 8.

Catalyst component was prepared as in example 10, but as phosphorous compound was used 1.31 g of tri phenyl phosphine.

P/Mg molar ratio as used during catalyst component preparation: 0.2

Catalyst component properties (wt-%):

Ti 5.5

DOP 20.0

Mg 10.1

### Example 15

Polymerisation was carried out as in example 4 using the catalyst component of example 14.

### Polymerisation Results:

Activity: 22.5

MFR₂: 9.7

XS: 2.6

MWD: 3.3

1. A process for preparing an olefin polymerization catalyst component in the form of particles having a predetermined size range of 5 to 200 μm, the process comprising the steps of:
a) preparing a solution of a complex of a Group 2 metal and an electron donor by reacting a compound of the Group 2 metal with the electron donor or a precursor thereof in an organic liquid reaction medium;
b) adding the solution of the complex to at least one compound of a transition metal to produce an emulsion having a dispersed phase, wherein the dispersed phase contains more than 50 mol % of the Group 2 metal in the complex;
c) agitating the emulsion in order to maintain the droplets of the dispersed phase within such an average size range of 5 to 200 μm;
d) solidifying said droplets of the dispersed phase; and
e) recovering the solidified particles of the olefin polymerization catalyst component;
wherein a phosphorous compound is added before recovering the solidified particles in step e).

2. The process of claim 1, wherein in step c) the emulsion is agitated in the presence of an emulsion stabilizer and/or a turbulence minimizing agent (TMA).

3. The process of claim 1, further comprising washing the solidified particles prior to recovering in step e).

4. The process according to claim 1, 2 or 3 wherein the phosphorous compound is added before recovering the solidified particles in step e) in an amount so that a molar ratio of Group 2 metal to phosphorous of 0.1 to 0.5 is obtained.

5. The process according to claim 3 wherein the phosphorous compound is brought into contact with the solidified particles during the washing step.

6. The process according to claim 1, 2 or 3 wherein the phosphorous compound comprises phosphorous in the oxidation state +3 or +5.

7. The process according to claim 1, 2 or 3, wherein the phosphorous compound is a compound of the formula O═P(OR)₃, wherein the three residues R may be identical or different and are selected from alkyls, alkenyls, aryls, and phenyls with 1 to 20 C-atoms, wherein the groups optionally may be substituted once or twice, preferably with any of the groups identified above and halogens.

8. The process according to claim 1, 2 or 3, wherein during the catalyst component preparation a compound of aluminum having a general formula AlR₃₋XₙX, where R stands for a straight chain or branched alkyl or alkoxy group having 1 to 20, X independently represents a residue selected from the group of halogen and alkyl and n stands for 0, 1, 2 or 3, is added and brought into contact with the droplets of the dispersed phase of the agitated emulsion before recovering the solidified particles in step e).

9. The process according to claim 1, 2 or 3 wherein the Group 2 metal is magnesium.

10. The process according to claim 1, 2 or 3 wherein the organic liquid reaction medium comprises a C₆-C₁₀ aromatic hydrocarbon or a mixture of C₆-C₁₀ aromatic hydrocarbon and C₅-C₈ aliphatic hydrocarbons.

11. The process according to claim 1, 2 or 3 wherein the organic liquid reaction medium comprises toluene.

12. The process according to claim 1 wherein the electron donor is a mono- or diester of an aromatic carboxylic acid or diacid.

13. The process according to claim 12 wherein the aromatic carboxylic acid ester or diester is formed in situ by reaction of an aromatic carboxylic acid chloride or diacid dichloride with a C₂-C₁₆ alkanol and/or diol.

14. The process according to claim 12 or 13 wherein the aromatic carboxylic acid ester is diethylhexyl phthalate.

15. The process according to claim 1 wherein the preparation of the Group 2 metal complex is carried out at a temperature of 20° to 80° C.

16. The process according to claim 15 wherein the Group 2 metal is magnesium and the preparation of the magnesium complex is carried out at a temperature of 50° to 70° C.

17. The process according to claim 1 wherein the transition metal is a Group 4 metal, a Group 5 metal and/or a Group 6 metal, or is Cu, Fe, Co, Ni and/or Pd or mixtures thereof.

18. The process according to claim 17 wherein the transition metal is a Group 4 metal.

19. The process according to claim 17 or 18 wherein the compound of the transition metal is a halide.

20. The process according to claim 1 wherein the mol ratio of the transition metal/Group 2 metal of the dispersed phase is 20 to 80.

21. The process according to claim 20 wherein the mol ratio of the transition metal/Group 2 metal of the dispersed phase is 45 to 75.

22. The process according to claim 1 wherein the Group 2 metal complex and the transition metal compound are reacted at a temperature of 10° to 60° C.

23. The process according to claim 22 wherein the Group 2 metal complex is a magnesium complex and the transition metal compound is a Group 4 metal compound which are reacted in a temperature ranging from 20° to 50° C.

24. The process according to claim 1 wherein the emulsion is composed of a first dispersed phase which is a toluene/TiCl₄-insoluble-oil having a Group 4 metal/Mg mol ratio greater than 0.1 and less than 10, and a second dispersed phase which is an oil less dense than that of the first dispersed phase and which has a Group 4 metal/Mg mol ratio of 10 to 100.

25. The process according to claim 24 wherein the Group 4 metal/Mg mol ratio of the first dispersed phase denser oil is 2 to 4 and that of the second dispersed phase oil is 55 to 65.

26. The process according to claim 2 wherein the emulsion stabilizer is a surfactant.

27. The process according to claim 26 wherein the surfactant comprises an acrylic polymer and/or methacrylic polymer.

28. The process according to claim 2 wherein a turbulence minimizing agent (TMA) is added to the reaction mixture before solidifying the droplets of the dispersed phase, the TMA being soluble in the reaction mixture under the reaction conditions.

29. The process according to claim 28 wherein the turbulence minimizing agent is selected from polymers of octane, nonene, decene, undecene, dodecene, copolymers and mixtures of polymers thereof.

30. A particle of the olefin polymerization catalyst component made according to the process of claim 1.

31. An olefin polymerization catalyst comprising particles of the olefin polymerization catalyst component made according to the process of claim 1, a cocatalyst, and optionally an external electron donor.

32-36. (canceled)

37. A polymer prepared using the olefin polymerisation catalyst according to claim 31, having a MWD of 3.9 or less.

38. The polymer in accordance with claim 37, wherein the polymer is a polymer comprising repeating units derived from olefins.
